(19) United States
(12) Patent Application Publication
(10) Pub. No.: US 2009/0141426 A1
(43) Pub. Date: Jun. 4, 2009

(54) THIN FILM MULTI-LAYERED CERAMIC CAPACITOR AND METHOD OF FABRICATING THE SAME

(76) Inventor: Cheol-Seong HWANG, Kyungki-do (KR)

Correspondence Address: LADAS & PARRY LLP, 224 SOUTH MICHIGAN AVENUE, SUITE 1600, CHICAGO, IL, 60604, US

(21) Appl. No.: 11/947,135

(22) Filed: Nov. 29, 2007

(51) Int. Cl. H01G 4/12; H01G 7/00

(52) U.S. Cl. 361/321.2; 29/25.41

(57) ABSTRACT

Provided are a thin film multi-layered ceramic capacitor and a method of fabricating the same. The thin film multi-layered ceramic capacitor includes a multi-layered structure including at least two capacitor layers stacked on top of each other. Each capacitor layer includes a substrate comprising a top surface comprising a plurality of holes, and a thin film capacitor including at least three electrode layers sequentially stacked on the top surface of the substrate along the holes, and dielectric layers respectively interposed between every two adjacent electrode layers. The electrode layers of each of the capacitor layers are alternately connected to a first external electrode and a second external electrode.

### BACKGROUND

The present disclosure relates to a thin film multi-layered ceramic capacitor (MLCC), and more particularly, to a thin film MLCC which is configured to have a miniaturized size while ensuring high capacitance, and a method of fabricating the same.

In general, the MLCC is a chip type capacitor having a stacked structure of a plurality of dielectric layers with printed electrodes, and is being widely used for a variety of electronic products. Recent market expansion of mobile communications devices and portable electronic devices is increasing demands for smaller MLCC products with higher capacity.

A related art MLCC is fabricated by the following processes: forming a multi-layered structure by stacking a plurality of green sheets each with electrode paste applied; and forming electrodes at both sides of the multi-layered structure. Such a bulk process has a limitation in achieving miniaturization and high capacity of the MLCC.

To overcome this limitation, researches are actively ongoing to introduce a semiconductor thin film process in the MLCC field. For example, a thin film MLCC fabrication method is disclosed in Japanese Patent Laid-Open Publication No. 2001-181839. In the thin film MLCC fabrication method, a (Ba, Sr) TiO₃ layer (hereinafter, referred to as a BST layer) having a high dielectric constant is deposited by using metal organic chemical vapor deposition (MOCVD). FIG. 1 is a cross-sectional view of a related art thin film MLCC which can be fabricated by using the aforementioned technology.

Referring to FIG. 1, the related art MLCC includes a plurality of Pt electrode layers 12 and 16 and a plurality of BST dielectric layers 14 disposed on a substrate 11 of, e.g., MgO. The MLCC can be fabricated by the following processes: forming electrode layers and dielectric layers by performing a sputtering process and an MOCVD process multiple times, and then patterning the electrode layers and the dielectric layers by performing a photolithography process and an etching process on each of the layers.

However, because the related thin film MLCC is two-dimensionally formed on a top surface of the substrate, an effective area that substantially determines capacitance is limited. In order to ensure high capacitance, the number of layers being stacked must be increased, and thus more photolithography and etching processes are required, making the entire fabrication process complicated.

Because of a limitation caused by a flat structure, the related art thin film MLCC has a limitation in ensuring required capacitance of approximately 10 μF or higher.

As another example of a related art, a micro capacitor using a silicon-on-insulator (SOI) substrate is disclosed in U.S. Pat. No. 6,421,224. According to the disclosure, the related art micro capacitor with a three-dimensional structure is provided by forming uniformly porous top and bottom surfaces of the SOI substrate by an etching process using an insulating layer of the SOI substrate as an etching stop layer, and forming dielectric layers and metal layers on the etched top and bottom surfaces. A small capacitor with high capacitance can be provided by stacking a plurality of micro capacitors. As for the micro capacitor, a surface area can increase by using a porous structure, and high capacitance can be ensured by using a stacked structure thereof. However, since a silicon layer and the insulating layer used as the etching stop layer remain between upper and lower electrodes besides the dielectric layer, capacitor characteristics may be deteriorated. Also, when the micro capacitors are stacked, a configuration of an input/output terminal is complicated.

A method of manufacturing a semiconductor device including a memory cell is disclosed in U.S. Pat. No. 6,503,791, in which a hole is formed and a thin film capacitor is formed on a surface including the hole. However, this structure is merely a capacitor cell structure for integration of a semiconductor device, and cannot be applied to a process of fabricating a high capacitance single capacitor such as an MLCC.

### SUMMARY

The present disclosure provides a thin film multi-layered ceramic capacitor (MLCC) which can be miniaturized while having high capacitance.

The present disclosure also provides a method of fabricating the thin film MLCC by using a semiconductor thin film process.

According to an exemplary embodiment, a thin film multi-layered ceramic capacitor includes a multi-layered structure including at least two capacitor layers stacked on top of each other. Each of the capacitor layers includes a substrate including a top surface including a plurality of holes; and a thin film capacitor including at least three electrode layers sequentially stacked on the top surface of the substrate along the holes, and dielectric layers respectively interposed between every two adjacent electrode layers. The electrode layers of each of the capacitor layers are alternately connected to a first external electrode and a second external electrode.

The first external electrode may be connected to the electrode layers by first contact plugs penetrating the thin film capacitor and alternately connected to the electrode layers, and the second external electrode may be connected to the electrode layer by a first contact plug penetrating the thin film capacitor and connected the electrode layer which is not connected to the first contact plug among the electrode layers.

The electrode layers of each capacitor layer may be configured such that a first electrode layer extending to one side of the substrate and a second electrode layer extending to the other side of the substrate are alternately stacked. The first external electrode may be disposed at one side of the multi-layered structure and connected to the first electrode layer, and the second external electrode may be disposed at the other side of the multi-layered structure and is connected to the second electrode layer. Step portions may be formed at both sides of the substrate, so that the first and second external electrodes can be more firmly attached. The plurality of holes may have a same depth, and the step portions have the almost same height as bottom surfaces of the holes.

Each of the capacitor layers may further include a passivation layer disposed on the thin film capacitor and having a flat top surface in order to improve flatness of the upper surface of the thin film capacitor.

The plurality of holes may have a hemispherical grain structure, a fin type hole structure, or a cylindrical structure in order to increase a surface area of the top surface of the substrate.

To increase an increase rate of the surface area, the plurality of holes each may have an aspect ratio of approximately 1 or greater, and the aspect ratio may be approximately 50 or less in due consideration of a coverage limitation with respect to inner surfaces of the holes when the electrode layers or dielectric layers are formed. That is, the plurality of holes may have an aspect ratio ranging from approximately 1 to approximately 50.

The electrode layer may be formed of at least one metal selected from the group consisting of Pt, Ru, Ir, Au, Ni, Mo, W, Al, Ta, Ag and Ti, or a conductive oxide or a conductive nitride of at least one metal selected from the group consisting of Pt, Ru, Sr, La, Ir, Au, Ni, Co. Mo, W, Al, Ta and Ti.

The dielectric layer may be formed of at least one high dielectric constant material selected from the group consisting of TiO₉, ZrO₂, Al₂O₃, Ta₂O₅, Nb₂O₅, HfO₂, SrTiO₃, BaTiO₃, (Ba, Sr)TiO₃, PbTiO₃, SrBi₂Ta₂O₉, (Pb, La)(Zr, Ti)O₃ and Pb(Zr, Ti)O₃, or a material prepared by adding a dopant thereto.

The at least two capacitor layers of the multi-layered structure may be bonded by using by using a thermosetting adhesive agent, an ultraviolet curable adhesive agent, or a mixture thereof. If the thermosetting adhesive agent is used, an adhesive agent curable at 100° C. or lower may be used in due consideration of deterioration of the dielectric layers caused by a high temperature.

According to another exemplary embodiment, a method of fabricating a thin film multi-layered ceramic capacitor includes: forming at least two capacitor layers, each including a substrate including a top surface including a plurality of holes, and a thin film capacitor including at least three electrode layers sequentially stacked on the top surface of the substrate along the holes and dielectric layers respectively interposed between every two adjacent electrode layers; forming a multi-layered structure by stacking the at least two capacitor layers on top of each other; and alternately connecting the electrode layers of each of the capacitor layers to a first external electrode and a second external electrode.

The alternate connecting of the electrode layers to the first external electrode and the second external electrode may include: forming first contact plugs penetrating the thin film capacitor and alternately connecting the electrode layers of each of the capacitor layer; forming the first external electrode connected to the first contact plugs; forming a second contact plug penetrating the thin film capacitor and connected to the electrode layer which is not connected to the first contact plugs; and forming the second external electrode connected to the second contact plug.

The forming of the at least two capacitor layers may include forming the electrode layers over the substrate including: forming a first electrode layer extending to one side of the substrate by depositing an electrode material and then patterning the deposited electrode material; forming a second electrode layer extending to the other side of the substrate by depositing an electrode material and then patterning the deposited electrode material; and repeating the forming of the first electrode layer and the forming of the second electrode layer. The first external electrode may be formed at one side of the multi-layered structure and connected to the first electrode layer, and the second electrode layer may be formed at the other side of the multi-layered structure and connected to the second electrode layer.

The forming of the capacitor layer may include forming the electrode layers and the dielectric layers by chemical vapor deposition (CVD) or atomic layer deposition (ALD).

The method of fabricating a thin film multi-layered ceramic capacitor may further include forming a passivation layer on top and side surface of the thin film capacitor; and exposing portions of the electrode layers placed on one side and the other side of the substrate by selectively removing the passivation layer before the alternately connecting of the electrode layers after the forming of the multi-layered structure.

The forming of the at least two capacitor layers may further include reducing a thickness of the capacitor layer by polishing a bottom surface of the substrate in order to miniaturize a final product.

### BRIEF DESCRIPTION OF THE DRAWINGS

Exemplary embodiments can be understood in more detail from the following description taken in conjunction with the accompanying drawings, in which:

FIG. 1 is a cross-sectional view of a related art thin film multi-layered ceramic capacitor;

FIG. 2 is a cross-sectional view of a thin film multi-layered ceramic capacitor according to an exemplary embodiment;

FIGS. 3A through 3I are cross-sectional views for explaining a method of fabricating a capacitor layer of a thin film multi-layered ceramic capacitor according to an exemplary embodiment;

FIGS. 4A and 4B are cross-sectional views for explaining a stacking process for completing a thin film multi-layered ceramic capacitor according to an exemplary embodiment;

FIG. 5 is a cross-sectional view of a thin film multi-layered ceramic capacitor according to another exemplary embodiment;

FIGS. 6A through 6H are cross-sectional views for explaining a method of fabricating a capacitor layer of a thin film multi-layered ceramic capacitor according to another exemplary embodiment; and

FIGS. 7A through 7C are cross-sectional views for explaining a stacking process for completing a thin film multi-layered ceramic capacitor according to another exemplary embodiment.

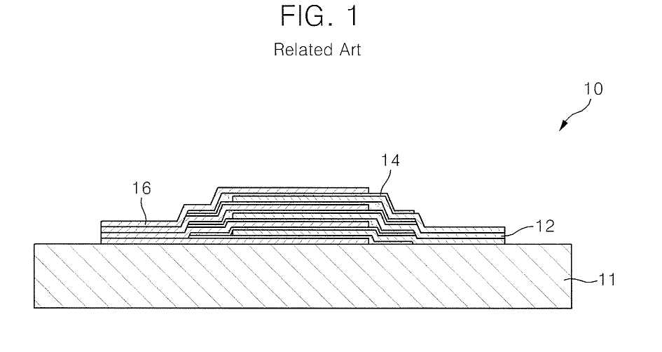

### DETAILED DESCRIPTION OF EMBODIMENTS

Hereinafter, specific embodiments will be described in detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Like reference numerals refer to like elements throughout.

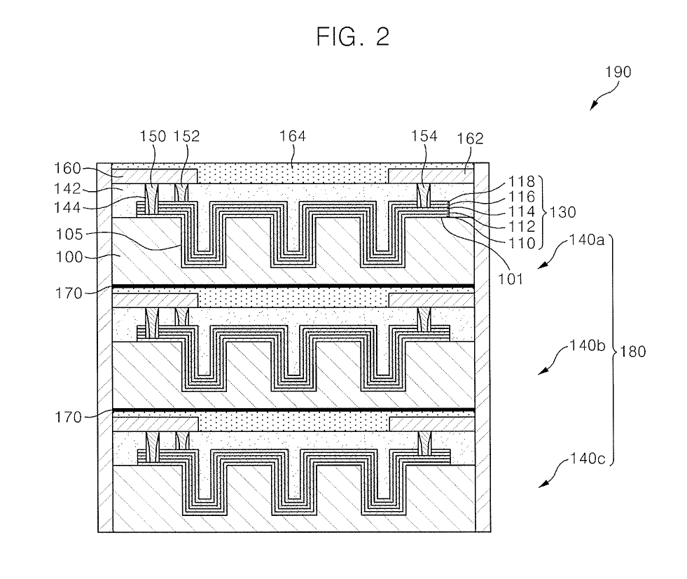

FIG. 2 is a cross-sectional view of a thin film multi-layered ceramic capacitor according to an exemplary embodiment.

Referring to FIG. 2, the thin film multi-layered ceramic capacitor 190 according to an exemplary embodiment includes a multi-layered structure 180 in which at least two capacitor layers are stacked on top of each other. In the drawing, three capacitor layers 140a, 140b and 140c are stacked. However, two or four or more capacitor layers may be used according to required capacitance and an acceptable product size. The stacked state of the capacitors 140a, 140b and 140c is maintained by an adhesive agent 170. The adhesive agent 170 may be a thermosetting adhesive agent, an ultraviolet curable adhesive agent, or a mixture thereof.

A structure of each of the capacitor layers 140a, 140b and 140c will now be described. Each of the capacitor layers 140a, 140b and 140c includes a substrate 100 including a top surface 101 including a plurality of holes 105, and a thin film capacitor 130. The thin film capacitor 130 includes three electrode layers 110, 114 and 118 sequentially stacked on the substrate 100, and dielectric layers 112 and 116 respectively interposed between every two adjacent electrodes. Each of the electrode layers 110, 114 and 118 may be formed of at least one metal selected from the group consisting of Pt, Ru, Ir, Au, Ni, Mo, W, Al, Ta, Ag and Ti, or a conductive oxide or a conductive nitride of at least one metal selected from the group consisting of Pt, Ru, Sr, La, Ir, Au, Ni, Co, Mo, W, Al, Ta and Ti. For the convenience in description, the three electrode layers 110, 114 and 118 will now be referred to as a lower electrode layer, an intermediate electrode layer, and an upper electrode layer, respectively. Each of the dielectric layers 112 and 116 is formed of at least one high dielectric constant material selected from the group consisting of TiO₂, ZrO₂, Al₂O₃, Ta₂O₅, Nb₂O₅, HfO₂, SrTiO₃, BaTiO₃, (Ba, Sr)TiO₃, PbTiO₃, SrBi₂Ta₂O₉, (Pb, La)(Zr, Ti)O₃ and Pb(Zr, Ti)O₃, or a material prepared by adding a dopant thereto. For example, each of the dielectric layer 112 and 116 may be a single layer of (Ba, Sr)TiO₃ or a double layer of Al₂O₃/HfO₂. Alternatively, each of the dielectric layers 112 and 116 may be a layer prepared by adding Hf to Al₂O₃ as a dopant or a layer prepared by adding Hf to TiO₂ as a dopant. Alternatively, each of the dielectric layers 112 and 116 may be a stacked layer of SiO₂ and Si₃N₄.

The holes 105 in the substrate 100 serve to increase a surface area of the top surface 101 of the substrate 100, and may have a variety of shapes such as a hemispherical grain structure, a fin-type hole structure or a cylindrical structure. An aspect ratio of the hole 105 is approximately 1 or higher to increase an surface area rate. The aspect ratio of the hole 105 may be approximately 50 or lower in due consideration of a coverage limitation with respect to an inner surface of the hole 105 in forming the electrode layers 110, 114 and 118 or the dielectric layer 112 and 116.

Passivation layers 142 and 164 are formed on a top surface of each of the capacitor layers 140a, 140b and 140c. The electrode layers 110, 114 and 118 of each of the capacitor layer 140a, 140b and 140c are alternately connected to a first external electrode 182 and a second external electrode 184. The first external electrode 182 and the second external electrode 184 serve to connect thin film capacitors 130 of the capacitor layers 140a, 140b and 140c in parallel, and have opposite polarities.

Specifically, the lower electrode layer 110 and the upper electrode layer 118 of each of the capacitor layers 140a, 140b and 140c are connected to a first line 160 by first contact plugs 150 and 152, respectively. The intermediate electrode layer 114 of each of the capacitor layers 140a, 140b and 140c is connected to a second line 162 by a second contact plug 154. The first line 160 of each of the capacitor layers 140a, 140b and 140c is connected to the first external electrode 182 disposed at one side of the multi-layered structure 180, and the second line 162 of each of the capacitor layers 140a, 140b and 140c is connected to the second external electrode 184 disposed at the other side of the multi-layered structure 180. Thus, the first external electrode 182 is connected to the electrode layers 110 and 118 of each of the capacitor layers 140a, 140b and 140c by the first contact plugs 150 and 152 that pass through the thin film capacitor 130 and are alternately connected to the electrode layers. The second external electrode 184 is connected to the electrode layer 114 of each of the capacitor layers 140a, 140b and 140c by the second plug 154 that pass through the thin film capacitor 130 and is connected to the electrode layer 114 which is not connected to the first contact plugs 150 and 152. A reference number 144 indicates a dielectric spacer for insulating the contact plugs 150, 152 and 154 from electrode layers excluding respective electrode layers connected thereto.

The illustrated electrode connection structure is merely an example. The electrode layers 110, 114 and 118 of each of the capacitor layers 140a, 140b and 140c may be directly and alternately connected to the first and second external electrodes 182 and 184 without using the first and second lines 160 and 162.

In the thin film multi-layered ceramic capacitor 190 illustrated in FIG. 2, each of the capacitor layers 140a, 140b and 140c includes the three electrode layers 110, 114 and 118 and the two dielectric layers 112 and 116. Thus, substantially, two sub-thin film capacitors, i.e., a two-layered tin film capacitor, are implemented on the holes 105. However, more than three electrode layers may be provided. Accordingly, an exemplary embodiment may be considered to correspond to a structure where n+1 electrode layers and n dielectric layers are provided and n sub-thin film capacitors, i.e., an n-layered thin film capacitor, are substantially stacked on holes (n is a natural number of 2 or greater). For example, if the size of the hole 105 is approximately 3 μm and each of layers such as the electrode layers 110, 114 and 118 and the dielectric layers 112 and 116 is stacked with a thickness of approximately 100 Å, total fifteen layers may be stacked until the hole 105 is completely filled up. This means that eight electrode layers and seven dielectric layers are stacked, and thus seven sub-thin film capacitors, i.e., a seven-layered thin film capacitor, are implemented. Thus, the surface area of the thin film capacitor increase by using the holes to thus increase capacitance as compared to that of a capacitor with a two-dimensional structure, and at least two sub-thin film capacitors are implemented on the holes, so that the number of capacitor layers within the multi-layered structure 180 can be reduced. Accordingly, a thin film multi-layered ceramic capacitor can be miniaturized while having high capacitance.

In the related art, there has been an example of increasing a surface area of a thin film capacitor by using a hole, but in this case, just one thin film capacitor is implemented on holes. To increases capacitance in a single thin film capacitor, the number of layers being stacked in a multi-layered structure must be increased or a hole size must be made to be smaller to increase the surface area by differently applying a costly photolithography process. According to an exemplary embodiment, thin electrode layers and dielectric layers implementing a thin film capacitor are provided, so that at least two sub-thin film capacitors are implemented on holes. Thus, desired capacitance can be sufficiently obtained with the small number of capacitor layers of a multi-layered structure, and there is no need to change a costly photolithography process for forming a micro pattern. For example, if fifty capacitor layers each implementing one thin film capacitor can achieve the desired capacitance in the related art, in an exemplary embodiment ten capacitor layers can achieve the same desired capacitance because five sub-thin film capacitors are implemented on holes in each capacitor layer by using thinner layers. Accordingly, a device size can be significantly minimized while the same capacitance is maintained. Also, since a thickness of each layer constituting a capacitor is reduced, capacitance of a single capacitor increases as compared to the related art capacitor.

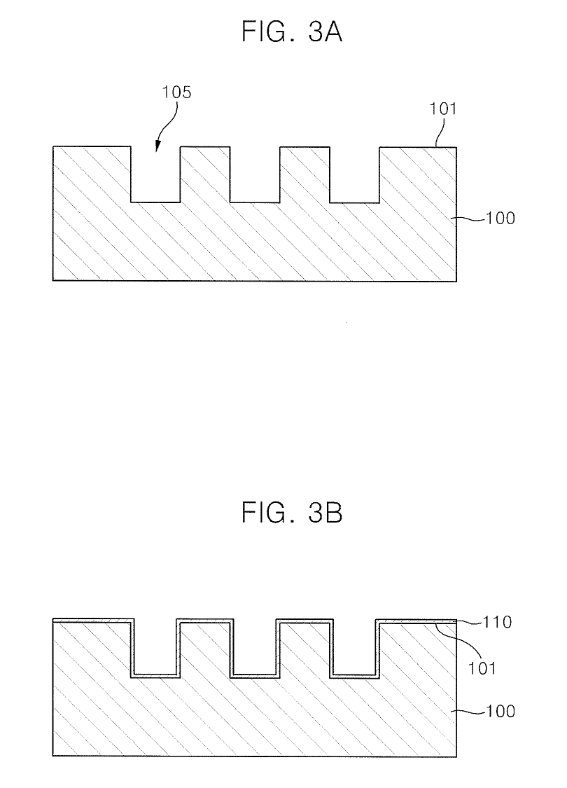

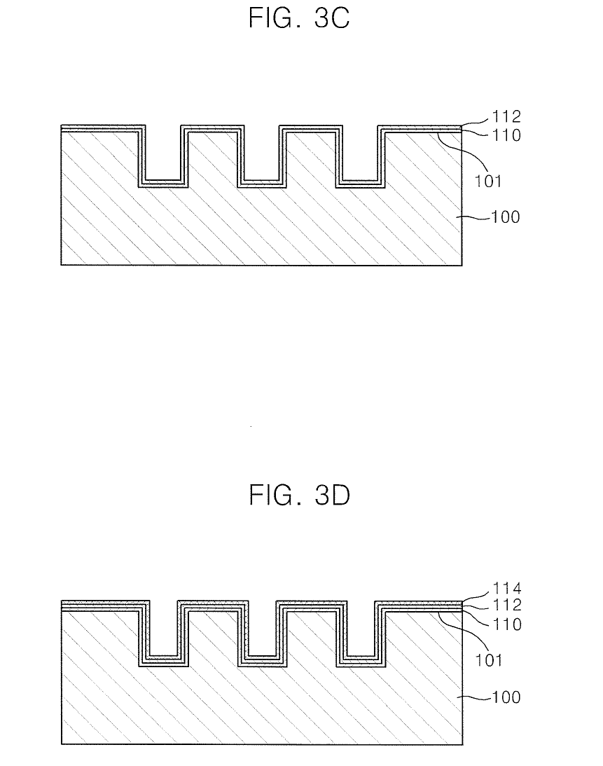

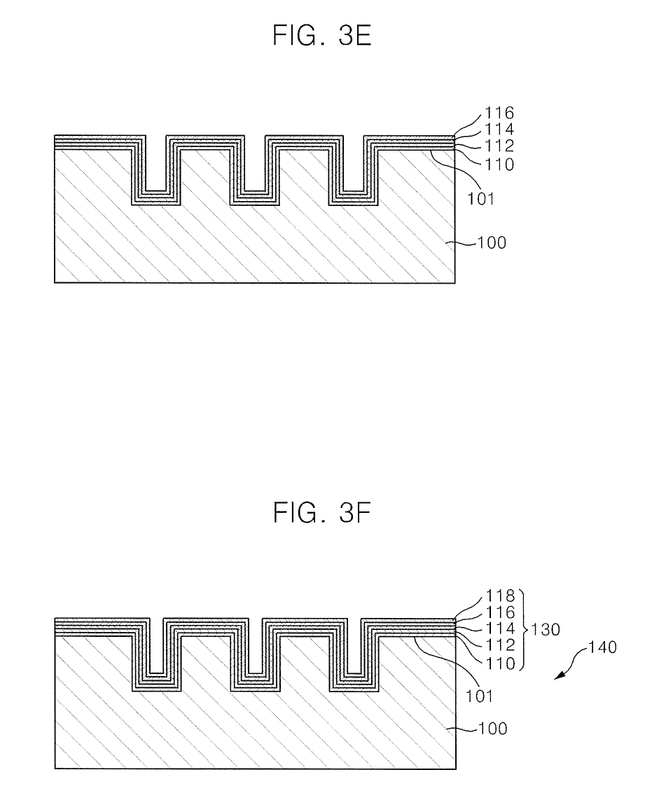

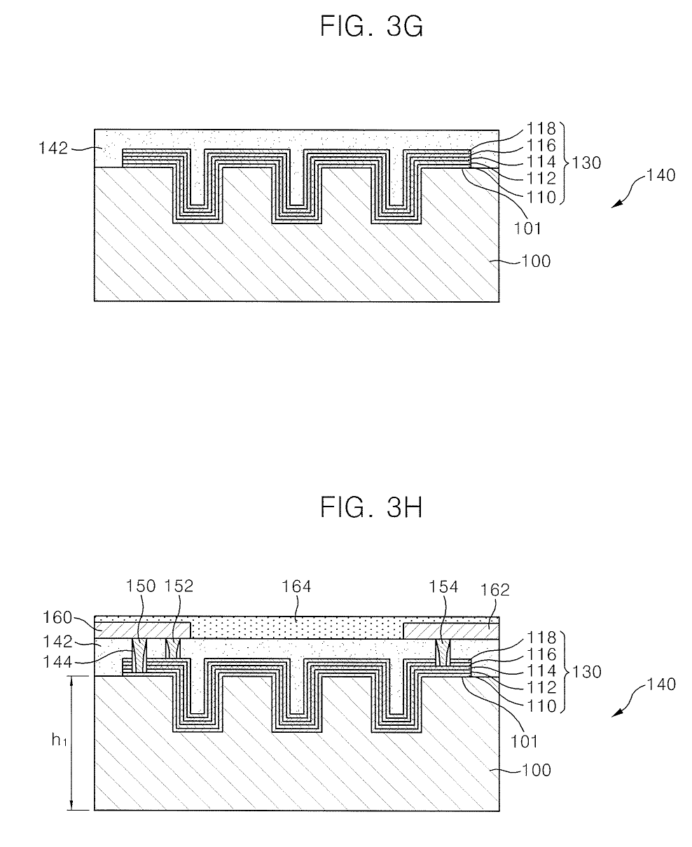

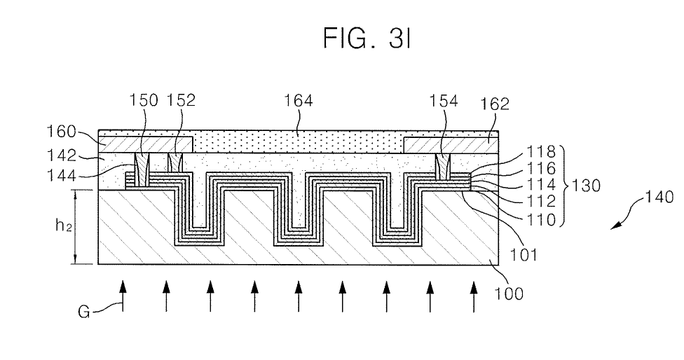

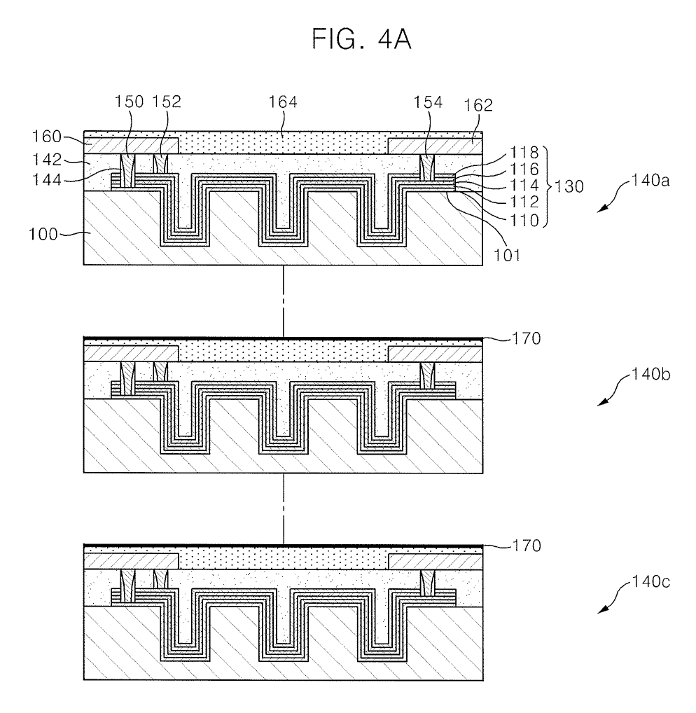

FIGS. 3A through 3I are cross-sectional views for explaining a method of fabricating a capacitor layer of a thin film multi-layered ceramic capacitor illustrated in FIG. 2.

Referring to FIG. 3A, a plurality of holes 105 are formed in a top surface 101 of a substrate 100. The plurality of holes 105 serve to increase a surface area of the top surface 101 of the substrate 100, and may have various shapes and be formed easily by a selective etching process used in a semiconductor process. For example, the holes 105 each may be formed as a hemispherical grain structure, a fin type hole structure, or a cylindrical structure. The holes 105 employed in this exemplary embodiment are formed as cylindrical shapes having the same depth by an anisotropic etching process. Each of the holes 105 is formed with an aspect ratio of approximately 1 or greater in order to sufficiently increase the surface area, and the aspect ratio thereof may be approximately 50 or less in due consideration of uniform coverage with respect to inner surface of the holes 105. The substrate 100 employed in this exemplary embodiment may be a silicon substrate that is widely used in a semiconductor process, but is not limited thereto. Any non-conductive substrate that is processable by a semiconductor process can be used as the substrate 100.

Referring to FIG. 3B a lower electrode layer 110 is formed on the substrate 100 as an initial electrode layer. The lower electrode layer 110 may be formed by a semiconductor layer formation process such as chemical vapor deposition (CVD) including metal-organic (MO) CVD or atomic layer deposition (ALD).

Since the deposition process has an excellent step coverage characteristic, the lower electrode layer 110 may be deposited with a uniform desired thickness even up to inner surfaces of the plurality of holes 105. Also, the lower electrode layer 110 may be formed of at least one metal selected from the group consisting of Pt, Ru, Ir, Au, Ni, Mo, W, Al, Ta, Ag and Ti, or a conductive oxide or a conductive nitride of at least one metal selected from the group consisting of Pt, Ru, Sr, La, Ir, Au, Ni, Co, Mo, W, Al, Ta and Ti, but a material of the lower electrode layer 110 is not limited thereto. A formation method of the lower electrode layer 110 may be different according to a selected material. For example, if Ru is selected for the lower electrode layer 110, the substrate 100 is previously thermally oxidized to form a thin thermal oxide layer, a Ta₂O₅ layer is deposited thereon to increase adhesiveness of Ru, and then Ru is deposited.

Referring to FIG. 3C, a first dielectric layer 112 is formed on the lower electrode layer 110 on the substrate 100. The first dielectric layer 112 may be formed by a semiconductor layer formation process such as the CVD including the MOCVD or the ALD, similarly to the forming process of the lower electrode layer 110.

The first dielectric layer 112 may be formed of at least one high dielectric constant material selected from the group consisting of TiO₂, ZrO₂, Al₂O₃, Ta₂O₅, Nb₂O₅, HfO₂, SrTiO₃, BaTiO₃, (Ba, Sr)TiO₃, PbTiO₃, SrBi₂Ta₂O₉, (Pb, La)(Zr, Ti)O₃ and Pb(Zr, Ti)O₃, or a material prepared by adding a dopant thereto. If necessary, plasma nitridation or thermal nitridation using an NH₃ gas may be performed on a surface of the lower electrode layer 110 before the first dielectric layer 112 is formed. By the plasma nitridation or thermal nitridation, a silicon nitride layer with a thickness ranging from approximately 10 Å to approximately 20 Å may be formed to prevent a possible reaction between the lower electrode layer 110 and the first dielectric layer 112. If necessary, an annealing process may be added after the first dielectric layer 112 is formed.

Referring to FIG. 3D, an intermediate electrode layer 114 is formed on the first dielectric layer 112, thereby obtaining a first sub-thin film capacitor including the lower electrode layer 110, the first dielectric layer 112 and the intermediate electrode layer 114. The intermediate electrode layer 114 may be formed by a semiconductor layer formation process such as the CVD including the MOCVD or the ALD, similarly to the forming process of the lower electrode layer 110. The intermediate electrode layer 114 may be formed of at least one metal selected from the group consisting of Pt, Ru, Ir, Au, Ni, Mo, W, Al, Ta, Ag and Ti or a conductive oxide or a conductive nitride of at least one metal selected from the group consisting of Pt, Ru, Sr, La, Ir, Au, Ni, Co, Mo, W, Al, Ta and Ti, but a material of the intermediate electrode layer 114 is not limited thereto.

Referring to FIG. 3E, a second dielectric layer 116 is formed on the intermediate electrode layer 114. The second dielectric layer 116 may be formed by a semiconductor layer formation process such as the CVD including the MOCVD or the ALD, similarly to the forming process of the first dielectric layer 112.

The second dielectric layer 116 may be formed of at least one high dielectric constant material selected from the group consisting of TiO₂, ZrO₂, Al₂O₃, Ta₂O₅, Nb₂O₅, HfO₂, SrTiO₃, BaTiO₃, (Ba, Sr)TiO₃, PbTiO₃, SrBi₂Ta₂O₉, (Pb, La)(Zr, Ti)O₃ and Pb(Zr, Ti)O₃, or a material prepared by adding a dopant thereto. If necessary, plasma nitridation or thermal nitridation may be further performed on the intermediate electrode layer 114, and an annealing process may be further performed on the second dielectric layer 116.

Referring to FIG. 3F, an upper electrode layer 118 is formed on the second dielectric layer 116, thereby obtaining a second sub-thin film capacitor including the intermediate electrode layer 114, the second dielectric layer 116 and the upper electrode layer 118. Accordingly, a two-layered thin film capacitor 130 is implemented, which includes the first sub-thin film capacitor including the lower electrode layer 110, the first dielectric layer 112 and the intermediate electrode layer 114, and the second sub-thin film capacitor including the intermediate electrode layer 114, the second dielectric layer 116 and the upper electrode layer 118. The upper electrode layer 118 may be formed by a semiconductor layer formation process such as the CVD including the MOCVD or the ALD, similarly to the forming process of the lower electrode layer 110. The upper electrode layer 118 may be formed of at least one metal selected from the group consisting of Pt, Ru, Ir, Au, Ni, Mo, W, Al, Ta, Ag and Ti or a conductive oxide or a conductive nitride of at least one metal selected from the group consisting of Pt, Ru, Sr, La, Ir, Au, Ni, Co, Mo, W, Al, Ta and Ti, but a material of the upper electrode layer 118 is not limited thereto.

In the method of fabricating a capacitor layer 140 of a thin film multi-layered ceramic capacitor according to an exemplary embodiment, a capacitor layer 140 is fabricated by forming a thin film capacitor on a top surface of the substrate including a plurality of holes by repetitively performing forming processes of an electrode-layer and a dielectric-layer. The thin film capacitor includes at least three electrode layers sequentially stacked on a substrate and dielectric layers respective interposed between every adjacent electrode layers. For example, as illustrated in the drawing, the capacitor layer 140 is formed by forming the two-layered thin film capacitor 130 on the top surface 101 of the substrate 100 including the plurality of holes 105. The thin film capacitor 130 includes the lower electrode layer 110, the intermediate electrode layer 114 and the upper electrode layer 118 sequentially stacked on the substrate 100 and the first dielectric layer 112 and the second dielectric layer 116 interposed between every two adjacent electrode layers 110 and 114, and 114 and 118. In this exemplary embodiment, the capacitor layer 140 includes three electrode layers and two dielectric layers and thus the two-layered thin film capacitor 130 is formed on the holes 105, but, as mentioned above, the number of electrode layers and the number of dielectric layers are not limited thereto. As electrode layers and dielectric layers are made thinner, more electrode layers and dielectric layers can be deposited on a substrate even if the hole size remains the same. The surface area of the thin film capacitor 130 according to this exemplary embodiment can increase by using the holes 105 to thus increase capacitance as compared to a two-dimensional capacitor. Also, since at least two sub-thin film capacitors are implemented on the holes 105, the number of capacitor layers 140 being stacked can be reduced. Accordingly, the thin film multi-layered ceramic capacitor can be miniaturized while having high capacitance.

The capacitor layer 140 may be additionally processed by selectively performing a passivation-layer forming process and a polishing process thereon. FIGS. 3G through 3I illustrate the additional passivation-layer forming process and polishing process that may be employed in an exemplary embodiment.

Referring to FIG. 3G, both sides of the thin film capacitor 130 are removed by patterning the thin film capacitor 130, and then a passivation layer 142 is formed thereon to planarize a top surface of the capacitor layer 140. Both sides of the thin film capacitor 130 are removed in order to prevent short circuit from occurring in connecting external electrode in a subsequent process. If the external electrodes have a structure that obviates short circuit, the process of patterning the thin film capacitor 130 can be omitted. The passivation layer 142 may be formed of an oxide, e.g., SiO₂ or a nitride e.g., Si₃N₄ like a general passivation layer. In this exemplary embodiment, the passivation layer 142 is further used to planarize the top surface of the capacitor layer 140.

If the holes 105 are filled up by the forming processes of the electrode layers 110, 114 and 118 and the dielectric layers 112 and 116 and thus flatness of the top surface of the upper electrode layer 118 is obtained, the passivation-layer forming process can be omitted. However, an increase in effective surface area can be expected when the electrode layers 110, 114 and 118 and the dielectric layers 112 and 116 are formed along the inner surfaces of the holes 105 as shown. For this reason, it may be difficult to make the surface of the upper electrode layer 118 flat.

Thereafter, first contact plugs 150 and 152 alternately connected with electrode layers are formed. Referring to FIG. 3H, the first contact plugs 150 and 152 are formed to pass through the thin film capacitor 130. In this exemplary embodiment, the first contact plug 150 is connected to the lower electrode layer 110, and the first contact plug 152 is connected to the upper electrode layer 118. Each of the first contact plugs 150 and 152 is surrounded by a dielectric spacer 144 so as to be insulated from electrode layers excluding an electrode layer connected thereto. Thereafter, a first line 160 is formed and connected to the first contact plugs 150 and 152. The first line 160 may be considered as an intermediate electrode for a connection with a first external electrode after a stacking process of the capacitor layers 140.

Thereafter, a second contact plug 154 connected to an electrode layer which is not connected to the first contact plugs 150 and 152 is formed to pass through the thin film capacitor 130. In this exemplary embodiment, the second contact plug 154 is connected to the intermediate electrode layer 114. The second contact plug 154 is surrounded by a dielectric spacer 144 so as to be insulated from electrode layers excluding the electrode layer connected thereto. Thereafter, a second line 162 is formed and connected to the second contact plug 154. The second line 163 may be considered as an intermediate electrode for a connection with a second external electrode after the stacking process of the capacitor layers 140. Then, a passivation layer 164 is further formed thereon in order to facilitate the stacking process.

Detailed processes may be performed in the following manner.

First, the first contact plugs 150 and 152 and the second contact plug 154 are formed by a contact hole etching process. This process may be performed by performing an etching mask operation and etching more than once. Thereafter, the dielectric spacer 144 is formed on inner surfaces of contact holes. The dielectric spacer 144 may be formed of the same material as that of the first and second dielectric layers 122 and 116. Thereafter, the contact holes are filled with a conductive material, thereby forming the first contact plugs 150 and 152 and the second contact plug 154. A conductive material, e.g., Ru, is deposited on the first contact plugs 150 and 152 and the second contact plug 154, and is patterned, so that the first line 160 connected to the first contact plugs 150 and 152 and the second line 162 connected to the second contact plug 154 are formed. The passivation layer 164 is formed on the first and second lines 160 and 162.

Referring to FIG. 3I, a thickness of the capacitor layer 140 is reduced from h₁ to h₂ by performing a polishing process G on a bottom surface of the substrate 100 of the capacitor layer 140. The polishing process may be a chemical mechanical polishing (CMP) process. Since the polishing process G removes an unnecessary lower portion of the substrate 100, a final product can be further miniaturized. The polishing process is a selective process like the process described with reference to FIG. 3G. That is, the polishing process can be omitted if a substrate has a sufficiently thin substrate. However, if a substrate with a relatively great thickness is required in order to facilitate the aforementioned layer forming and etching processes, the polishing process may be performed to reduce the thickness of the capacitor layer 140.

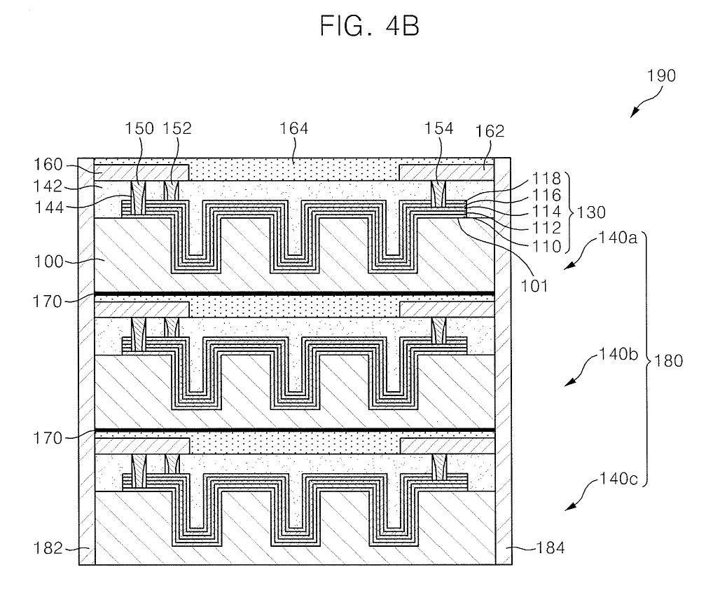

The thin film multi-layered ceramic capacitor according to an exemplary embodiment is completed by the following processes: stacking at least two capacitor layers fabricated by the processes illustrated in FIGS. 3A through 3I on top of each other, and alternately connecting electrode layers of a multi-layered structure to the first external electrode and the second external electrode. The stacking process for completing the thin film multi-layered ceramic capacitor according to an exemplary embodiment will now be described with reference to FIGS. 4A and 4B.

Referring to FIG. 4A, three capacitor layers 140a, 140b and 140c each fabricated by the processes of FIGS. 3A through 3I are provided. Thereafter, an adhesive agent 170 is applied on top surfaces of the capacitor layers 140b and 140c that are to contact bottom surfaces of other capacitor layers 140a and 140b. In this exemplary embodiment, the adhesive agent 170 is applied on the top surfaces of the capacitor layers 140b and 140c, but an application position of the adhesive agent 170 is not limited thereto. The adhesive agent 170 may be applied to at least one set of top surfaces and bottom surfaces of the capacitor layers 140b and 140c and 140a and 140b, respectively without affecting an adhesion effect, as is apparent to those skilled in the art. An insulating resin may be used for the adhesive agent 170. A thermosetting adhesive agent, an ultraviolet curable adhesive agent, or a mixture thereof may be used as the adhesive agent 170. However, the adhesive agent, particularly, the thermosetting adhesive agent may be able to stably maintain its adhesiveness under a general soldering temperature condition. In this exemplary embodiment, three capacitor layers are stacked but the number of capacitor layers being stacked is not limited thereto. Two or four or more capacitor layers may be used depending on required capacitance and an acceptable product size.

Referring to FIG. 4B, a multi-layered structure 180 is formed by stacking the three capacitor layers 140a, 140b and 140c with the adhesive agent 170 applied therebetween. Thereafter, a first external electrode 182 is formed at one side of the multi-layered structure 180, and a second external electrode 184 is formed at the other side of the multi-layered structure 180. The first external electrode 182 and the second external electrode 184 are respectively connected to the first lines 160 and the second lines 162 placed on both side portions of the multi-layered structure 180. In such a manner, the thin film multi-layered ceramic capacitor 190 is completed. The first and second external electrodes 182 and 184 may be formed by a known electrode forming process such as a deposition process, a plating process and a printing process. The first and second external electrodes 182 and 184 may be formed of a known material such as Ru, Au, Pd, Ni Ag or an alloy thereof. The first and second external electrodes 182 and 184 connect thin film capacitors 130 of the capacitor layers 140a, 140b and 140c in parallel, thereby implementing a multi-layered structure.

In this exemplary embodiment, the adhesive agent 170 is used. However, as is apparent to those skilled in the art, a desired multi-layered structure may be formed by a known pressing/heating process. In more detail, a multi-layered structure as illustrated in FIG. 4B can be obtained by performing heating within a temperature range where the dielectric layers 112 and 116 are not deteriorated, and pressing at high pressure, without using the adhesive agent 170.

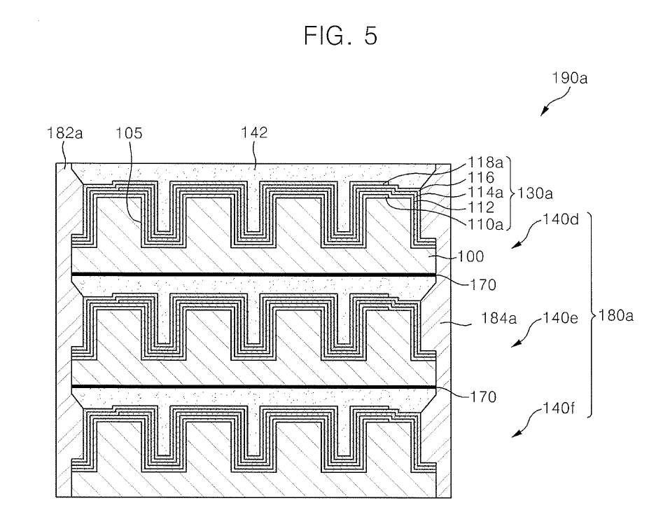

FIG. 5 is a cross-sectional view of a thin film multi-layered ceramic capacitor according to another exemplary embodiment.

Referring to FIG. 5, the thin film multi-layered ceramic capacitor 190a according to another exemplary embodiment includes a multi-layered structure 180a including at least two capacitor layers stacked on top of each other. In another exemplary embodiment, three capacitor layers 140d, 140e and 140f are stacked but, as mentioned above, the number of capacitor layers being stacked is not limited thereto.

A structure of each of the capacitor layers 140d, 140e and 140f will now be described. Each of the capacitor layer 140d, 140e and 140f includes a substrate 100 including a top surface 101 in which a plurality of holes 105 are formed, and a thin film capacitor 130a. The thin film capacitor 130a includes three electrode layers 110a, 114a and 118a sequentially stacked on the substrate 100 along the holes 10, and dielectric layers 112 and 116 respective interposed between every two adjacent electrode layers.

The electrode layers 110a, 114a and 118a of each of the capacitors 140d, 140e and 140f are alternately connected to the first external electrode 182a and the second external electrode 184a. The first external electrode 182a and the second external electrode 184 serve to connect thin film capacitors of the capacitor layers 140e, 140e and 140f in parallel.

In detail, the electrode layers 110a, 1104a and 118a are stacked such that the electrode layers 110a and 118a extending to one side of the substrate 100 and the electrode layer 114a extending to the other side of the substrate 100 are alternately stacked on top of each other. Hereinafter, the electrode layers 110a and 118a may be referred to as first electrode layers, and the electrode layer 114a may be referred to as a second electrode. The first electrode layers 110a and 118a extending to one side of the substrate 100 are connected to the first external electrode 182a formed at one side thereof, and the second electrode layer 114a extending to the other side of the substrate 100 is connected to the second external electrode 184 formed at the other side thereof.

In the thin film multi-layered ceramic capacitor 190a of FIG. 5, each of the capacitor layers 140d, 140e and 140f include three electrode layers 110a, 114a and 118 and two dielectric layers 112 and 116, and thus a two-layered thin film capacitor is substantially formed on the holes 105 in each of the capacitor layers 140d, 140e and 140f. However, as described above, each capacitor layer may include more than three electrode layers. Accordingly, another exemplary embodiment may be considered to correspond to a structure where n+1 electrode layers and n dielectric layers are provided, and thus n sub-thin film capacitors, i.e., an n-layered thin film capacitor, are substantially stacked on holes (n is a natural number of 2 or greater). The surface area of the thin film capacitor increases by using the holes to thus increase capacitance as compared to that of a capacitor with a two-dimensional structure, and at least two sub-thin film capacitors, i.e., at least two sub-thin film capacitors, are implemented on the holes, so that the number of capacitor layers being stacked can be reduced. Accordingly, a thin film multi-layered ceramic capacitor can be miniaturized while having high capacitance.

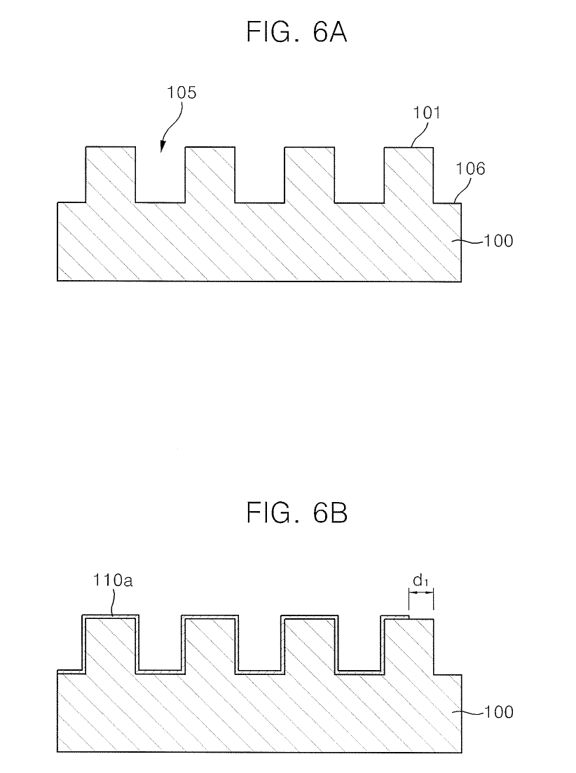

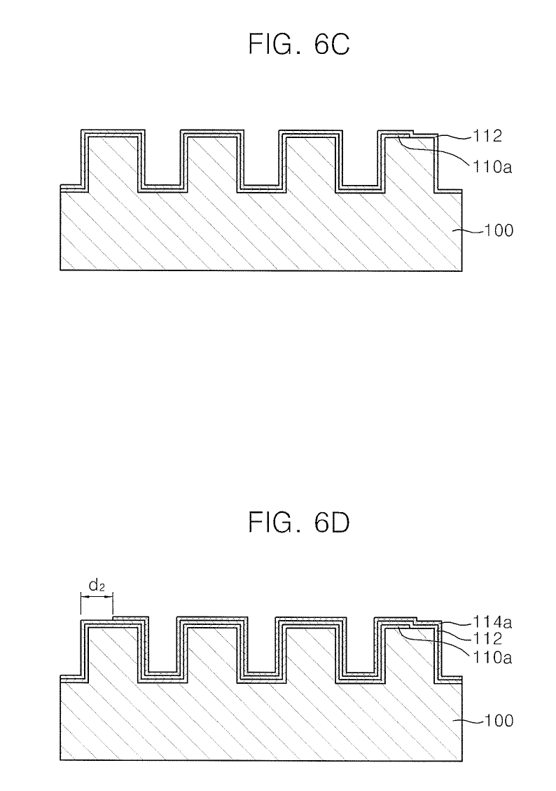

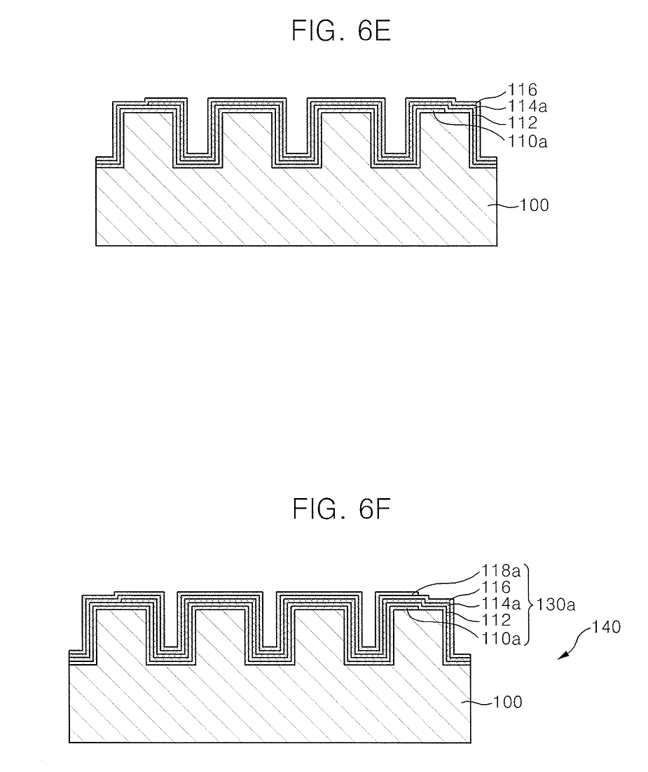

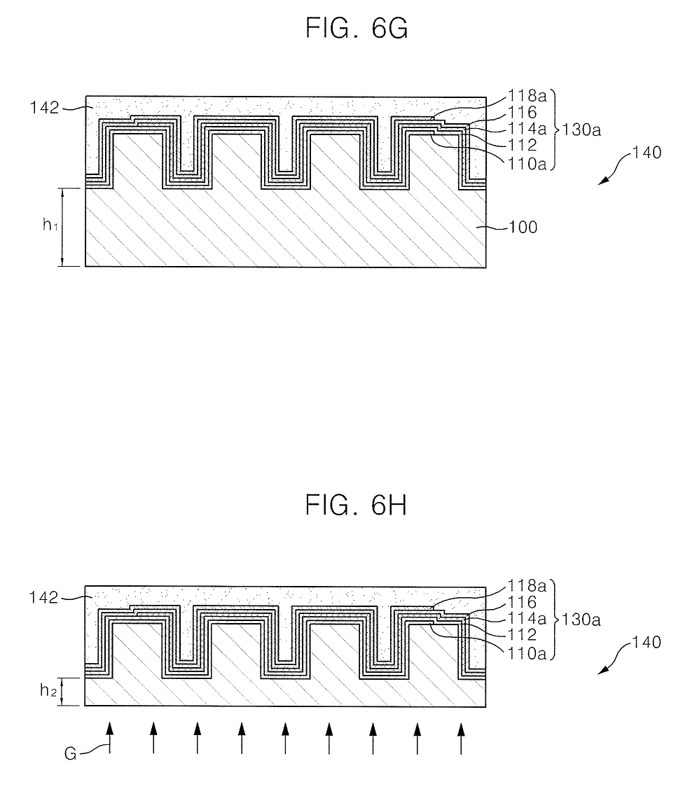

FIGS. 6A through 6H are cross-sectional views for explaining a method of fabricating a capacitor layer of a thin film multi-layered ceramic capacitor as illustrated in FIG. 5.

Referring to FIG. 6A, a plurality of holes 105 are formed in a top surface 101 of a substrate 100. Step portions 106 may be formed at both sides of the substrate 100. Of course, the step portions 106 may not be formed as in an exemplary embodiment of FIG. 2. The step portions 106 may be formed simultaneously with the holes 105 by a selective etching process used to form the holes 105. In this case, the step portions 106 have the same height as a bottom surface of the hole 105.

Referring to FIG. 6B, a lower electrode layer 110a is formed on the substrate 100 as a first electrode layer extending to one side of the substrate 100. The lower electrode layer 110a may be formed by performing the same deposition method and using the same material as those for the lower electrode layer 110 of the previous exemplary embodiment. As shown, the lower electrode layer 110a is formed on the substrate 100 including inner surfaces of the holes 105 up to one side portion of the substrate 100, but is not formed on the other side portion of the substrate 100 opposite to the one side thereof. Accordingly, undesired short circuit of external electrodes 182a and 184a of FIG. 5 formed at both sides can be prevented.

The lower electrode layer 110a may be formed by the following processes: depositing an electrode material on the top surface 101 of the substrate 100 and etching a portion of the electrode material deposited on the other side portion of the substrate 100. As shown in FIG. 6B, during the etching process, a portion d1 of the electrode material on a top portion adjacent to the other side portion of the substrate 100 may be further removed, so that short circuit with an intermediate electrode layer 114a of FIG. 6D to be subsequently grown can be stably prevented.

Referring to FIG. 6C, a first dielectric layer 112 is formed on the lower electrode layer 110a on the top surface 101 of the substrate 100. If necessary, a patterning process may be further performed on the first dielectric layer 112.

Referring to FIG. 6D, the intermediate electrode layer 114a is formed on the first dielectric layer 112 as a second electrode layer, thereby obtaining a first sub-thin film capacitor including the lower electrode layer 110a, the first dielectric layer 112 and the intermediate electrode layer 114a. The intermediate electrode layer 114a may be formed by performing the same deposition method and using the same material as those for the lower electrode layer 110 of the previous exemplary embodiment. As shown, the intermediate electrode layer 114a is formed on the first dielectric layer 112 and extends up to the other side of the substrate 100. The intermediate electrode layer 114a is not formed on the one side portion of the substrate opposite to the other side portion of the substrate 100. Therefore, the intermediate electrode layer 114 and the lower electrode layer 110a can be separately connected to external electrodes that are respectively formed at both sides.

The intermediate electrode layer 114a may be formed by a deposition process and a selective etching process of an electrode material, which are similar to the aforementioned processes for forming the lower electrode layer 110a. As shown in FIG. 6D, a portion d2 of the electrode material on a top portion adjacent to the one side portion of the substrate 100 may be further removed, so that short circuit with the lower electrode layer 110a can be effectively prevented.

Referring to FIG. 6E, a second dielectric layer 116 is formed on the intermediate electrode layer 114a. Similarly to the forming process of the first dielectric layer 112, the second dielectric layer 116 may be formed by a general semiconductor layer formation process such as CVD or ALD.

Referring to FIG. 6F, an upper electrode layer 118a is formed on the second dielectric layer 116 as a first electrode layer, thereby forming a second sub-thin film capacitor including the intermediate electrode layer 1140a, the second dielectric layer 116 and the upper electrode layer 118a. The first sub-thin film capacitor and the second sub-thin film capacitor constitute a thin film capacitor 130a. The upper electrode layer 118a may be formed by performing the same deposition method and using the same material as those for the lower electrode layer 110 of the previous exemplary embodiment. As shown, the upper electrode layer 118a is formed on the top surface of the substrate 100 including the holes 105 and up to the one side portion thereof, and is not formed on the other side portion opposite to the one side portion of the substrate.

As mentioned above, the electrode layers 110a, 114a and 118a are stacked such that the first electrode layers 110a and 118a extending to one side of the substrate 100 and the second electrode layer 114a extending to the other side facing the one side thereof are alternately stacked. In the method of fabricating a capacitor layer of a thin film multi-layered ceramic capacitor according to another exemplary embodiment, a capacitor layer 140 is fabricated by forming a thin film capacitor on a top surface of the substrate including a plurality of holes by repetitively performing forming processes of an electrode-layer and a dielectric-layer. The thin film capacitor includes at least three electrode layers sequentially stacked on a substrate and dielectric layers respective interposed between every adjacent electrode layers. For example, as shown in the drawing, the capacitor layer 140 is formed by forming the doubled-layered thin film capacitor 130a on the top surface 101 of the substrate 100 including the plurality of holes 105. The thin film capacitor 130 includes the lower electrode layer 110a, the intermediate electrode layer 114a and the upper electrode layer 118a sequentially stacked on the substrate 100 and the first dielectric layer 112 and the second dielectric layer 116 interposed between every two adjacent electrode layers 110 and 114, and 114 and 118. In another exemplary embodiment, the capacitor layer 140 includes the three electrode layers and the two dielectric layers and thus the two-layered thin film capacitor 130a is formed on the holes 105, but, as mentioned above, the number of electrode layers and the number of dielectric layers are not limited thereto. Thus, another exemplary embodiment may be considered to correspond to a structure where n+1 electrode layers and n dielectric layers are provided, and thus n sub-thin film capacitors, i.e., an n-layered thin film capacitor, are substantially stacked on holes (n is a natural number of 2 or greater). The surface area of the thin film capacitor 130a can increase by using the holes 105 to thus increase capacitance as compared to a two-dimensional capacitor. Also, since at least two sub-thin film capacitors are implemented on the holes 105, the number of capacitor layers being stacked can be reduced. Accordingly, the thin film multi-layered ceramic capacitor can be miniaturized while having high capacitance.

The capacitor layer 140 may be additionally processed by selectively performing a passivation-layer forming process and a polishing process thereon. FIGS. 6G through 6H illustrate the additional passivation-layer forming process and polishing process that may be employed in another exemplary embodiment.

Referring to FIG. 6G, a passivation layer 142 for planarization is formed on the capacitor layer 140. However, if the holes 105 is filled up by the forming processes of the electrode layers 110a, 114a and 118a and the dielectric layers 112 and 116 and the flatness of the top surface of the final upper electrode layer 118 is maintained, the passivation-layer forming process can be omitted. However, when the electrode layers 110a, 114a and 118a and the dielectric layers 112 and 116 are formed along the inner surfaces of the holes 105 as shown, an increase in effective surface area can be expected. For this reason, it may be difficult to make the surface of the upper electrode layer 118a flat.

Referring to FIG. 6H, a thickness of the capacitor layer 140 is reduced from h₁ to h₂ by performing a polishing process G on a bottom surface of the substrate 100 of the capacitor layer 140.

The thin film multi-layered ceramic capacitor according to another exemplary embodiment is completed by the following processes: stacking at least two capacitor layers each fabricated by the processes illustrated in FIGS. 6A through 6H on top of each other, and alternately connecting electrode layers of a stacked multi-layered structure to a first external electrode and a second external electrode.

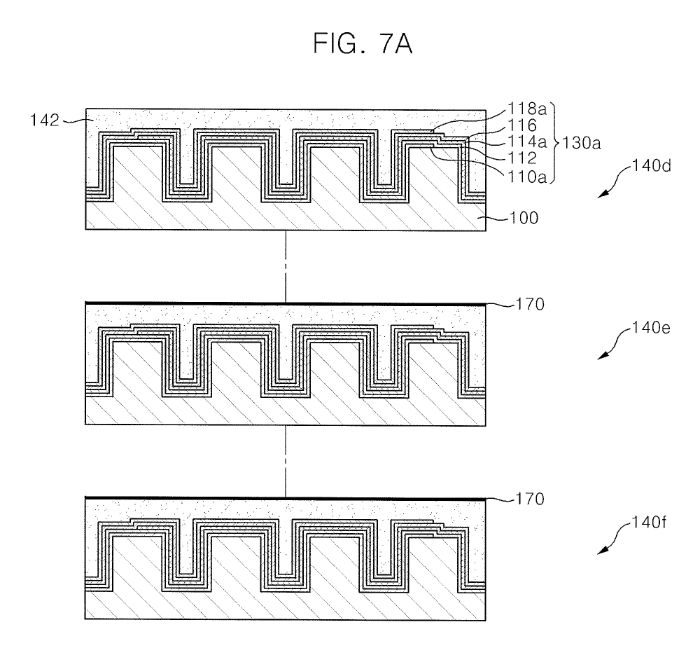

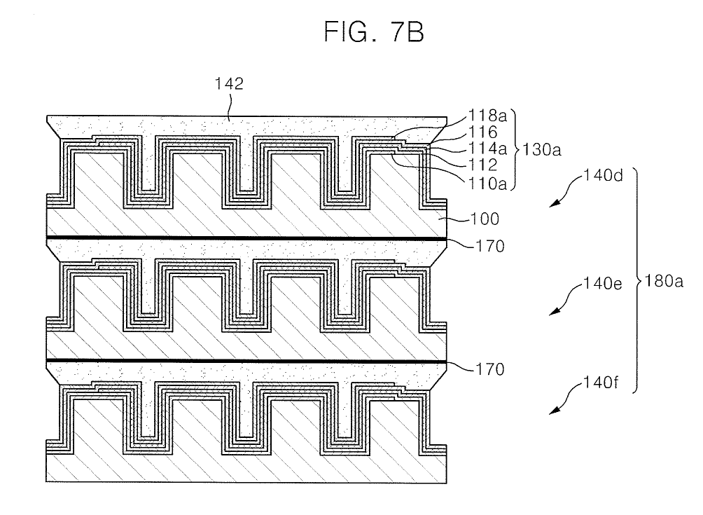

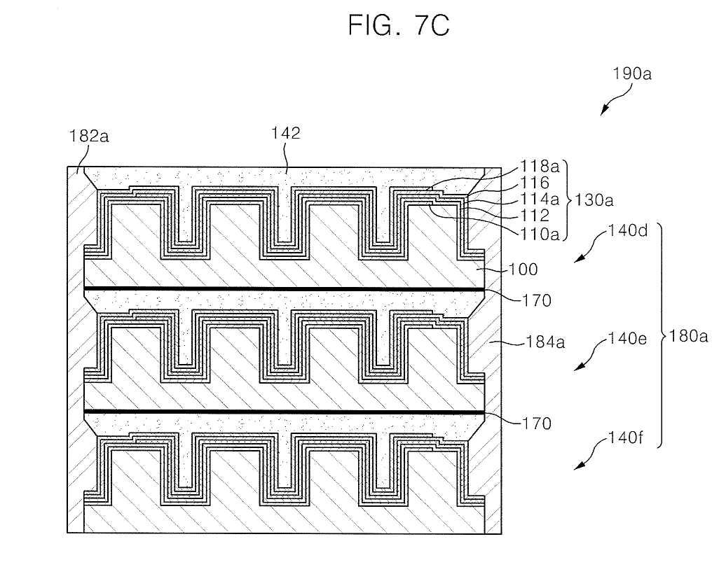

The stacking process for completing the thin film multi-layered ceramic capacitor according to another exemplary embodiment will now be described with reference to FIGS. 7A through 7C.

Referring to FIG. 7A, three capacitor layers 140d, 140e and 140f each fabricated by the processes of FIGS. 6A through 6H are provided. Thereafter, an adhesive agent 170 is applied on top surfaces of the capacitor layers 140e and 140f that are to contact bottom surfaces of other capacitor layers 140d and 140e.

Referring to FIG. 7B, the three capacitor layers 140d, 140e and 140f are stacked on top of each other with the adhesive agent 170 applied, thereby forming a multi-layered structure 18a. Thereafter, portions of the electrode layers 110a, 114a and 118a placed at both sides of the multi-layered structure 180a are exposed by etching the passivation layer 142. The capacitor-layer stacking process may be performed by hardening the adhesive agent using, e.g., heat and/or UV light with pressure maintained. The portion of the passivation layer 142 placed at side portions of the multi-layered structure 180a are removed, thereby exposing the first electrode layers 110a and 118a at one side of the substrate 100, and the second electrode layer 114a at the other side of the substrate 100.

Referring to FIG. 7C, the thin film multi-layered ceramic capacitor 190a is completed by forming first and second external electrodes 182a and 184a at the exposed electrode layers 110a, 114a and 118a at both sides of the multi-layered structure 180a. That is, the first external electrode 182a is formed at one side of the multi-layered structure 180 and connected to the first electrode layers 110a and 118a, and the second external electrode 184a is formed at the other side of the multi-layered structure 180a and connected to the second electrode layer 114a. As described with reference to FIG. 6A, the first and second external electrodes 182a and 184a can be more firmly attached by the prepared step portions 106.

A method of fabricating a thin film multi-layered ceramic capacitor according to exemplary embodiments can be more easily performed at wafer-level. That is, a forming process of at least two capacitor layers as described in the previous exemplary embodiments is performed by performing a plurality of different wafer level processes for each capacitor layer of the multi-layered structure. Plurality of wafers are used as a substrate of the capacitor layer, have the same size and the same capacitor-layer arrangement. Each wafer includes at least one capacitor layer. Thereafter, the process of forming the multi-layered structure is performed by stacking a plurality of wafers each including at least one capacitor layer, and cutting a stacked structure of the wafers so as to form at least one multi-layered structure. Accordingly, the method of fabricating a thin film multi-layered ceramic capacitor can be implemented to be suitable for mass production.

A method of fabricating a wafer level capacitor layer may be performed similarly to the processes described with reference to FIGS. 3A through 3I or the processes described with reference to FIGS. 6A through 6H, except that when the holes 105 of FIG. 3A or 6A are formed, an isolation region having the same depth as the hole 105 is formed so that capacitor layers have a distance therebetween. Also, in order to form a stacked structure, at least two wafers each including at least two capacitor layer structures are fabricated by separate wafer level processes. The wafers have the same size and the same capacitor-layer arrangement, and each wafer includes at least one capacitor layer.

Thereafter, the plurality of wafers are stacked on top of each other by using an adhesive unit such as an adhesive agent. As mentioned above, a thermosetting adhesive agent, an UV curable adhesive agent or a mixture thereof may be used as the adhesive agent. The adhesive agent may be applied on at least one of top and bottom surfaces of each wafer. Alternatively, the adhesion of the plurality of wafers may be performed by a pressing process using high temperature/high pressure according to exemplary embodiments.

Thereafter, a multi-layered structure obtained by stacking the plurality of wafers on top of each other is cut along the isolation region to separate thin film multi-layered ceramic capacitor structures. Accordingly, a plurality of thin film multi-layered ceramic capacitor structures obtained from the wafer level process can be collectively mass-produced.

For formation of the first and second external electrodes, the first and second lines placed at both side portions of the multi-layered structure are exposed in the case of an exemplary embodiment of FIG. 2, while the first and second electrode layers are exposed in the case of another exemplary embodiment of FIG. 5.

A thin film multi-layered ceramic capacitor according to exemplary embodiments is fabricated by stacking at least two unit capacitor layers, each of which includes at least three electrode layers and at least two dielectric layers on holes to substantially implement at least two sub-thin film capacitors. Since a surface area of the thin film capacitor increases by using the holes, capacitance can increase as compared to a capacitor with a two-dimensional structure, and the number of capacitor layers stacked within the stacked structure can be reduced by implementing at least two sub-thin film capacitors on the holes. Accordingly, the thin film multi-layered ceramic capacitor can be miniaturized while having higher capacitance.

Although the thin film multi-layered ceramic capacitor and a method of fabricating the same have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A thin film multi-layered ceramic capacitor comprising a multi-layered structure comprising at least two capacitor layers stacked on top of each other, each comprising:
a substrate comprising a top surface comprising a plurality of holes; and
a thin film capacitor comprising at least three electrode layers sequentially stacked on the top surface of the substrate along the holes, and dielectric layers respectively interposed between every two adjacent electrode layers,
wherein the electrode layers of each of the capacitor layers are alternately connected to a first external electrode and a second external electrode.

2. The thin film multi-layered ceramic capacitor of claim 1, wherein the first external electrode is connected to the electrode layers by first contact plugs penetrating the thin film capacitor and alternately connected to the electrode layers, and
the second external electrode is connected to the electrode layer by a first contact plug penetrating the thin film capacitor and connected the electrode layer which is not connected to the first contact plug among the electrode layers.

3. The thin film multi-layered ceramic capacitor of claim 1, wherein the electrode layers of each capacitor layer are configured such that a first electrode layer extending to one side of the substrate and a second electrode layer extending to the other side of the substrate are alternately stacked.

4. The thin film multi-layered ceramic capacitor of claim 3, wherein the first external electrode is disposed at one side of the multi-layered structure and connected to the first electrode layer, and the second external electrode is disposed at the other side of the multi-layered structure and is connected to the second electrode layer.

5. The thin film multi-layered ceramic capacitor of claim 4, wherein step portions are formed at both sides of the substrate.

6. The thin film multi-layered ceramic capacitor of claim 5, wherein the plurality of holes have a same depth, and the step portions have the same height as bottom surfaces of the holes.

7. The thin film multi-layered ceramic capacitor of claim 1, wherein each of the capacitor layers comprises a passivation layer disposed on the thin film capacitor and having a flat top surface.

8. The thin film multi-layered ceramic capacitor of claim 1, wherein the plurality of holes have a hemispherical grain structure, a fin type hole structure, or a cylindrical structure.

9. The thin film multi-layered ceramic capacitor of claim 1, wherein the plurality of holes each have an aspect ratio ranging from approximately 1 to approximately 50.

10. The thin film multi-layered ceramic capacitor of claim 1, wherein the electrode layer is formed of at least one metal selected from the group consisting of Pt, Ru, Ir, Au, Ni, Mo, W, Al, Ta, Ag and Ti.

11. The thin film multi-layered ceramic capacitor of claim 1, wherein the electrode layer is formed of a conductive oxide or a conductive nitride of at least one metal selected from the group consisting of Pt, Ru, Sr, La, Ir, Au, Ni, Co. Mo, W, Al, Ta and Ti.

12. The thin film multi-layered ceramic capacitor of claim 1, wherein the dielectric layer is formed of at least one high dielectric constant material selected from the group consisting of TiO₂, ZrO₂, Al₂O₃, Ta₂O₅, Nb₂O₅, HfO₉, SrTiO₃, BaTiO₃, (Ba, Sr)TiO₃, PbTiO₃, SrBi₂Ta₂O₉, (Pb, La)(Zr, Ti)O₃ and Pb(Zr, Ti)O₃, or a material prepared by adding a dopant thereto.

13. The thin film multi-layered ceramic capacitor of claim 1, wherein the at least two capacitor layers of the multi-layered structure are bonded with each other by using a thermosetting adhesive agent, an ultraviolet curable adhesive agent, or a mixture thereof.

14. A method of fabricating a thin film multi-layered ceramic capacitor, the method comprising:
forming at least two capacitor layers, each comprising a substrate comprising a top surface comprising a plurality of holes, and a thin film capacitor comprising at least three electrode layers sequentially stacked on the top surface of the substrate along the holes and dielectric layers respectively interposed between every two adjacent electrode layers;
forming a multi-layered structure by stacking the at least two capacitor layers on top of each other; and
alternately connecting the electrode layers of each of the capacitor layers to a first external electrode and a second external electrode.

15. The method of claim 14, wherein the alternate connecting of the electrode layers to the first external electrode and the second external electrode comprises:
forming first contact plugs penetrating the thin film capacitor and alternately connecting the electrode layers of each of the capacitor layer;
forming the first external electrode connected to the first contact plugs;
forming a second contact plug penetrating the thin film capacitor and connected to the electrode layer which is not connected to the first contact plugs; and
forming the second external electrode connected to the second contact plug.

16. The method of claim 14, wherein the forming of the at least two capacitor layers comprises forming the electrode layers over the substrate,
the forming of the electrode layers comprising:
forming a first electrode layer extending to one side of the substrate by depositing an electrode material and then patterning the deposited electrode material;
forming a second electrode layer extending to the other side of the substrate by depositing an electrode material and then patterning the deposited electrode material; and
repeating the forming of the first electrode layer and the forming of the second electrode layer.

17. The method of claim 16, wherein the first external electrode is formed at one side of the multi-layered structure and connected to the first electrode layer, and the second electrode layer is formed at the other side of the multi-layered structure and connected to the second electrode layer.

18. The method of claim 14, wherein the forming of the capacitor layer comprises forming the electrode layers and the dielectric layers by chemical vapor deposition (CVD) or atomic layer deposition (ALD).

19. The method of claim 14, further comprising:
forming a passivation layer on top and side surface of the thin film capacitor; and
exposing portions of the electrode layers placed on one side and the other side of the substrate by selectively removing the passivation layer before the alternately connecting of the electrode layers after the forming of the multi-layered structure.

20. The method of claim 14, wherein the forming of the at least two capacitor layers further comprises reducing a thickness of the capacitor layer by polishing a bottom surface of the substrate.
